(19) United States
(12) Patent Application Publication
(10) Pub. No.: US 2026/0057286 A1
(43) Pub. Date: Feb. 26, 2026

(54) HISTORICAL DATA RETENTION FOR AD MACHINE LEARNING MODELS

(71) Applicant: Snap Inc., Santa Monica, CA (US)

(72) Inventors: Yichuan Niu, Newark, CA (US); Yilun Xu, Santa Clara, CA (US); Haoyan Cai, Sunnyvale, CA (US); Feng Cai, San Jose, CA (US); Peng Yang, San Jose, CA (US)

(21) Appl. No.: 18/810,155

(22) Filed: Aug. 20, 2024

(51) Int. Cl. G06N 20/00; G06Q 30/0242

(52) U.S. Cl. CPC G06N 20/00; G06Q 30/0246

(57) ABSTRACT

Described is a system for training a machine learning model by collecting a first dataset comprising ad impression data and ad conversion data over a first time period; training a first machine learning model using the first dataset; collecting a second dataset comprising ad impression data and ad conversion data over a second time period; selecting a subset of the first dataset; training a second machine learning model using a combined dataset of the subset of the first dataset and the second dataset to generate a second trained machine learning model configured to generate predicted ad conversion rates for new ads; applying a plurality of ads to the second trained machine learning model to receive individual predicted ad conversion rates for each of the plurality of ads; and ranking the ads based on the predicted ad conversion rates.

### TECHNICAL FIELD

The present disclosure relates generally to machine learning models, and more specifically to historical data retention for ad machine learning models.

### BACKGROUND

As the popularity of online mobile applications grows, companies use data analysis techniques to provide recommended content to users, such as through impressions of advertisements. Platforms identify ad metrics to determine which ads are more relevant for a particular user. These recommendations aim to keep users engaged with the platform by showing them ads that is relevant and interesting to them. Based on the collected data of the user, companies create a user profile that is used to identify relevant content on their platforms.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of an interaction system that has both client-side and server-side functionality, according to some examples.

FIG. 3 is a diagrammatic representation of a data structure as maintained in a database, according to some examples.

FIG. 4 illustrates an architectural diagram highlighting the inherent fallbacks associated with such an approach, according to some examples

FIG. 5 illustrates an example method for training an predictive ad conversion machine learning model using historical data retention, according to some examples.

FIG. 6 illustrates an architectural diagram of historical data retention for ad performance prediction machine learning models, according to some examples.

FIG. 7 illustrates an aspect of the subject matter in accordance with one embodiment.

FIG. 8 illustrates dual model training architecture, according to some examples.

FIG. 9 is a diagrammatic representation of a message, according to some examples.

FIG. 10 illustrates a system including a head-wearable apparatus with a selector input device, according to some examples.

FIG. 11 is a diagrammatic representation of a machine in the form of a computer system within which a set of instructions may be executed to cause the machine to perform any one or more of the methodologies discussed herein, according to some examples.

FIG. 12 is a block diagram showing a software architecture within which examples may be implemented.

FIG. 13 illustrates a machine-learning pipeline, according to some examples.

FIG. 14 illustrates training and use of a machine-learning program, according to some examples.

### DETAILED DESCRIPTION

Traditional systems for training machine learning models in the ad ranking space typically rely on a sliding window approach for data handling, which has several inherent fallbacks. In such conventional approaches, a first model (e.g., ML1) is trained using data from a first time period (e.g., 6/1—June 1st to 7/1—July 1st). On the next day, traditional systems train the second model (ML2) using data from an incremental time period (e.g., 7/2 only) to perform model incremental training, which includes a substantial smaller amount of data.

This use of shorter period of data for model incremental training can lead to overfitting. The model becomes too finely tuned to the recent data's specific characteristics, potentially impairing its ability to generalize well to new, unseen data.

Moreover, as the incremental training proceeds forward, older data (e.g., from early June) is completely phased out after a month. This leads to a scenario where by the time it's early July, the model no longer considers any of June's data in its training.

This rapid cycling through data sets without a mechanism to retain earlier information contributes to what is known as catastrophic forgetting in neural networks. The model loses its ability to recall or utilize older but potentially still relevant information, which could be detrimental, especially in environments where past trends and patterns may still hold predictive power.

Traditional model incremental training approaches do not account well for long-term patterns or seasonal trends that extend beyond the immediate past time period of data (e.g., month's worth of data). This limitation can be particularly challenging in the ad space, where understanding and leveraging long-term user behavior and seasonal trends can be crucial for optimizing ad performance.

These fallbacks highlight the limitations of traditional systems in maintaining a balance between adapting to new data and retaining valuable insights from older data. The traditional approach often leads to a narrow focus on recent trends at the expense of a comprehensive understanding, which is essential for sustained performance in dynamic markets like online advertising.

Example embodiments of an interaction system described herein mitigate or eliminate the fallbacks described herein. The interaction system applies historical data retention to address the fallbacks of traditional sliding window approaches in several effective ways.

By integrating a historical data retention strategy, the system reduces the risk of overfitting on recent data. Instead of solely relying on the most recent dataset, the system incorporates a curated subset of older data alongside the new data. This mixture helps maintain a broader view, ensuring that the model is trained on a more diverse dataset. Such diversity in training data helps the model generalize better by learning from both past and present patterns, thus avoiding the excessive fine-tuning to recent anomalies or noise that typically leads to overfitting.

The interaction system significantly improves the model's ability to retain valuable information from older data by systematically including historical data in the training process. Instead of discarding older data after it ages out of the immediate training window, the system retains a strategic subset of this data. This method ensures that important patterns and trends that could still influence future outcomes remain part of the model's knowledge base. As a result, the model maintains performance consistency over time, even as new data cycles in.

By maintaining and utilizing historical data, the system enhances its adaptability to detect and leverage long-term and seasonal trends. This capability is crucial in the ad ranking context, where consumer behavior can show significant seasonal shifts. Traditional models might miss these patterns if they only train on a short, recent window of data. The interaction system, with its retention of a historical perspective, can better adapt its predictions and rankings to reflect both current and historically relevant behaviors.

The system allows for dynamic adjustments in how much historical data to retain based on specific needs, such as the availability of data or the specific characteristics of the ad campaign. For smaller companies or new market entrants with less historical data, the system can adjust to use a larger proportion of available historical data to enhance the model's effectiveness. Conversely, for well-established campaigns with extensive data histories, the system can optimize by selecting the most relevant historical data, thereby maintaining a manageable dataset size without compromising the depth of historical insight.

By continuously updating its data pool with a combination of recent and historical data, the system ensures that each model iteration is built on a comprehensive foundation of learned patterns. This approach leads to more accurate and reliable ad ranking, as the model's predictions are based on a fuller understanding of both past and present user interactions and preferences.

Overall, the interaction system's method of incorporating historical data retention fundamentally enhances the machine learning model's robustness, accuracy, and long-term applicability in the dynamic field of ad ranking.

When the effects in this disclosure are considered in aggregate, one or more of the methodologies described herein may improve known systems, providing additional functionality (such as, but not limited to, the functionality mentioned above), making them easier, faster, or more intuitive to operate, and/or obviating a need for certain efforts or resources that otherwise would be involved in the machine learning model training process. Computing resources used by one or more machines, databases, or networks may thus be more efficiently utilized or even reduced.

### Networked Computing Environment

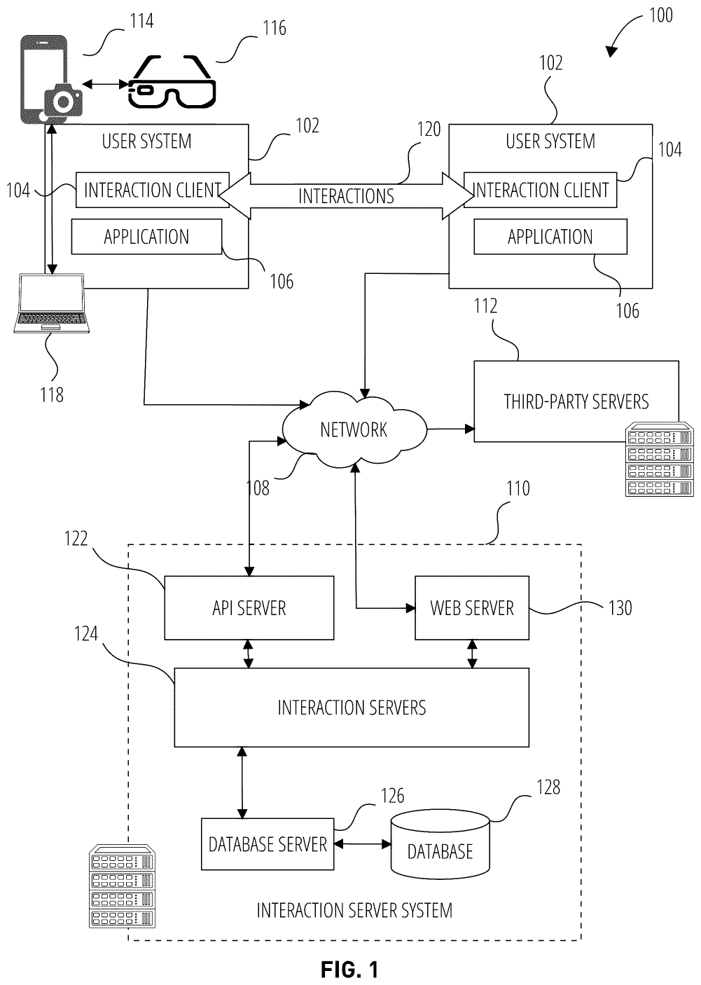

FIG. 1 is a block diagram showing an example interaction system 100 for facilitating interactions (e.g., exchanging text messages, conducting text audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Programming Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the other interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 110, an API server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The API server 122 receives and transmits interaction data (e.g., commands and message payloads) between the interaction servers 124 and the user systems 102 (and, for example, interaction clients 104 and other application 106) and the third-party server 112. Specifically, the API server 122 provides a set of interfaces (e.g., routines and protocols) that can be called or queried by the interaction client 104 and other applications 106 to invoke functionality of the interaction servers 124. The API server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity relationship graph (e.g., the entity graph 310); the location of friends within an entity relationship graph; and opening an application event (e.g., relating to the interaction client 104).

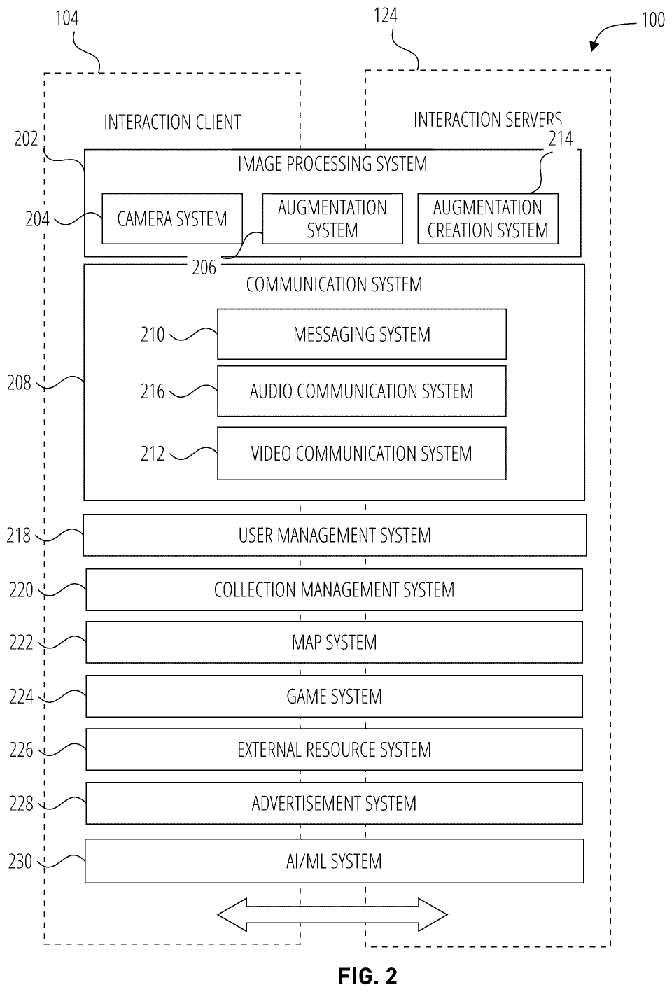

The interaction servers 124 hosts multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from third-party servers 112 for example, a markup-language document associated with the small-scale application and processing such a document.

In response to determining that the external resource is a locally installed application 106, the interaction client 104 instructs the user system 102 to launch the external resource by executing locally stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different applications 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of a microservice subsystem may include:
Function logic: The function logic implements the functionality of the microservice subsystem, representing a specific capability or function that the microservice provides.
API interface: Microservices may communicate with other component through well-defined APIs or interfaces, using lightweight protocols such as REST or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 902 of a user system 102. These augmentations are selected by the augmentation system 206 and presented to a user of an interaction client 104, based on a number of inputs and data, such as for example:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 308, entity graphs 310 and profile data 302) regarding users and relationships between users of the interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes APIs with functions that can be called or invoked by the web-based application. The interaction servers 124 hosts a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a graphical user interface (GUI) of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

An artificial intelligence and machine learning system 230 provides a variety of services to different subsystems within the interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the augmentation system 206 to generate augmented content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the interaction server system 110. The artificial intelligence and machine learning system 230 may also work with the audio communication system 216 to provide speech recognition and natural language processing capabilities, allowing users to interact with the interaction system 100 using voice commands.

### Data Architecture

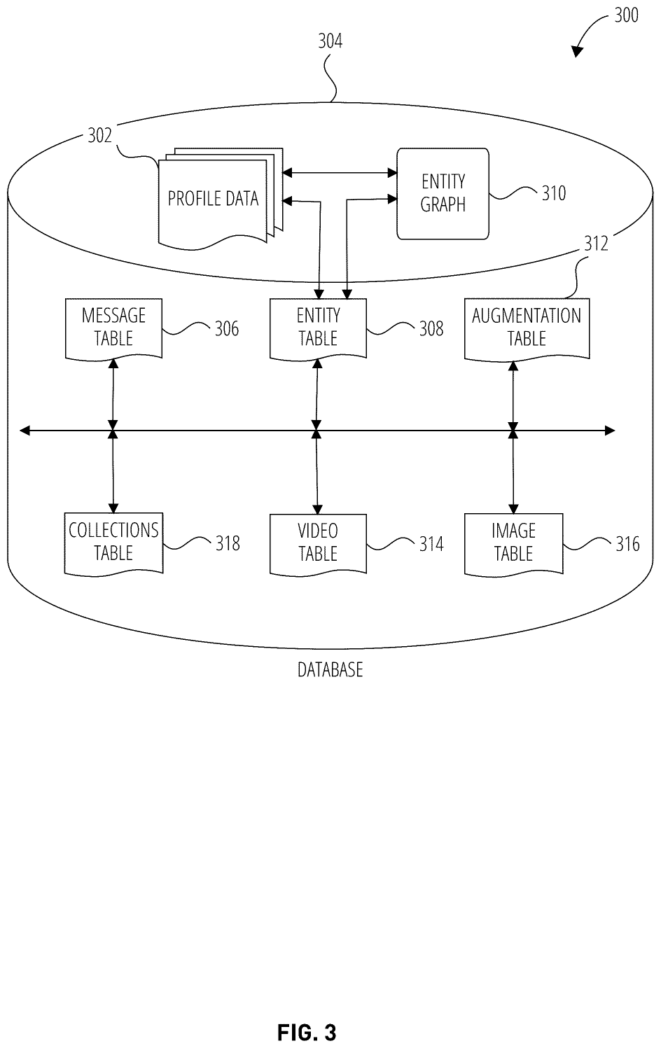

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database). In some cases, the database 304 includes features of or corresponds to database 128 in FIG. 1, and/or vice versa.

The database 304 includes message data stored within a message table 306. This message data includes, for any particular message, at least message sender data, message recipient (or receiver) data, and a payload. Further details regarding information that may be included in a message and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100. A friend relationship can be established by mutual agreement between two entities. This mutual agreement may be established by an offer from a first entity to a second entity to establish a friend relationship, and acceptance by the second entity of the offer for establishment of the friend relationship.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “lenses” or augmented reality experiences). An augmented reality content item may be a real-time special effect and sound that may be added to an image or a video.

A collections table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

### Traditional Systems for Training an Ad Impression and Conversion Estimator Machine Learning Model

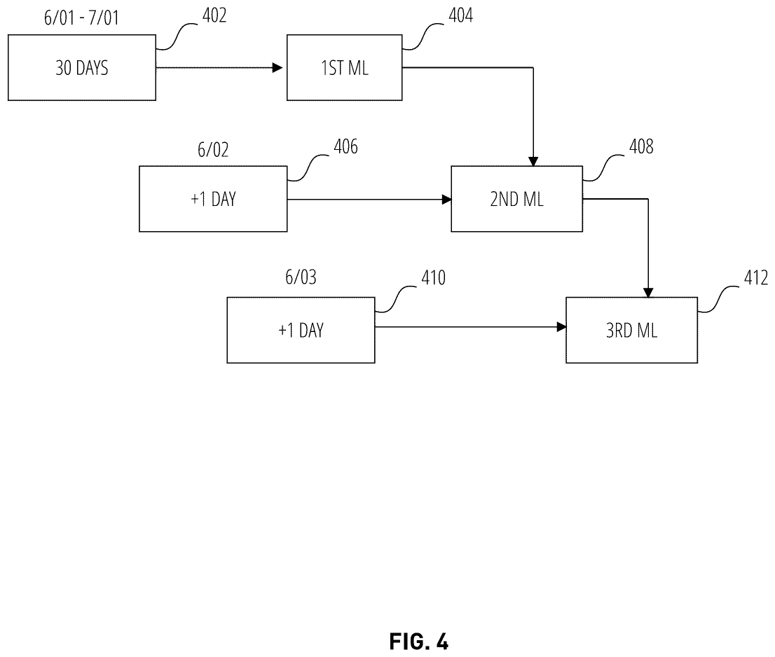

In traditional systems for machine learning, particularly in the context of ad ranking and engagement models, a common approach involves using daily data or a sliding window of data to continuously update and train new models. FIG. 4 illustrates an architectural diagram highlighting the inherent fallbacks associated with such an approach, according to some examples.

The process begins with collecting 30 days of training data during a first time period 402, from June 1 to July 1. This dataset forms the basis for the initial model training of the first machine learning model 404. The selection of a n-day (n=1 in most cases) window is intended to capture a day's worth of data, providing a comprehensive snapshot of user behavior and ad interactions within that period. However, it is appreciated that the features described herein can be applied to other time windows, such a week, a few days, a year, etc. However, using a longer period such as a month will significantly increase the training time and cost. In most case, such drastic cost increase is unacceptable.

The use of a fixed, 1-day window can lead to models that are heavily biased towards the trends, events, and behaviors present in that specific timeframe. This can limit the model's ability to generalize to conditions outside of these dates. Additionally, any significant changes in user behavior or market conditions that begin just after the data collection period will not be captured, potentially rendering the model less effective almost as soon as it is deployed.

A first machine learning model (1st ML) is trained using the 30 days of training data collected. This initial model serves as a baseline for subsequent updates and refinements. By training on this set, the model aims to establish foundational knowledge of ad performance metrics such as click-through rates and conversion rates.

On the next day, a new set of training data from a second time period 406 (e.g., July 2) is collected. This represents a shorter window where the start date is incremented by one day, intended to include the most recent data while maintaining a consistent training window length. This approach seeks to incrementally update the model's knowledge by integrating the most recent user interactions and ad performance data.

This data is used to train a second machine learning model (2nd ML 408). The 2nd ML model is initialized from the state of the former machine learning model (e.g., 1st ML), leveraging the learned parameters as a starting point to refine and adjust based on the new data set. This step is intended to build upon the existing model knowledge, gradually integrating more recent data while hoping to retain the relevant information from earlier training. It aims to make the model adaptive and responsive to new trends without starting from scratch each time.

Initializing the 2nd ML model from the 1st ML model can propagate errors and biases from the first model into the second. Moreover, the reliance on a narrowly updated data window can exacerbate overfitting, especially if recent data anomalies or noise are present. This method may also lead to a compounding of errors if consecutive models increasingly drift from foundational data trends due to small but repeated adjustments based solely on the most recent data.

The process continues with new training data collected in a third time period 410 (e.g., July 3), used to train the third machine learning model (3rd ML 412). Similar to the transition from the 1st to the 2nd model, the 3rd ML model uses the 2nd ML model as its starting point. This rolling update process aims to continuously refine the model's predictions by integrating the latest available data, ideally capturing shifts in user behavior and market dynamics quickly and effectively.

As further described herein, this approach suffers from the potential rapid forgetting of older, yet still relevant data as newer data shifts the focus of the model's learning. The narrow focus on recent trends can lead to a “recency bias,” where older but significant patterns are ignored, potentially impacting the model's overall effectiveness. Furthermore, the ongoing reliance on incremental updates may not allow the model sufficient opportunities to reevaluate and learn from earlier data periods comprehensively, possibly leading to degraded performance over time if critical historical trends are not adequately considered.

These steps illustrate the traditional challenges of model training in dynamic environments like ad ranking, where the balance between updating knowledge and retaining useful historical insights is crucial. The process in FIG. 4, while aiming to maintain model relevance, shows the difficulty in achieving this balance with traditional sliding window methods.

### Training an Ad Impression and Conversion Estimator Machine Learning Model Using Historical Data Retention

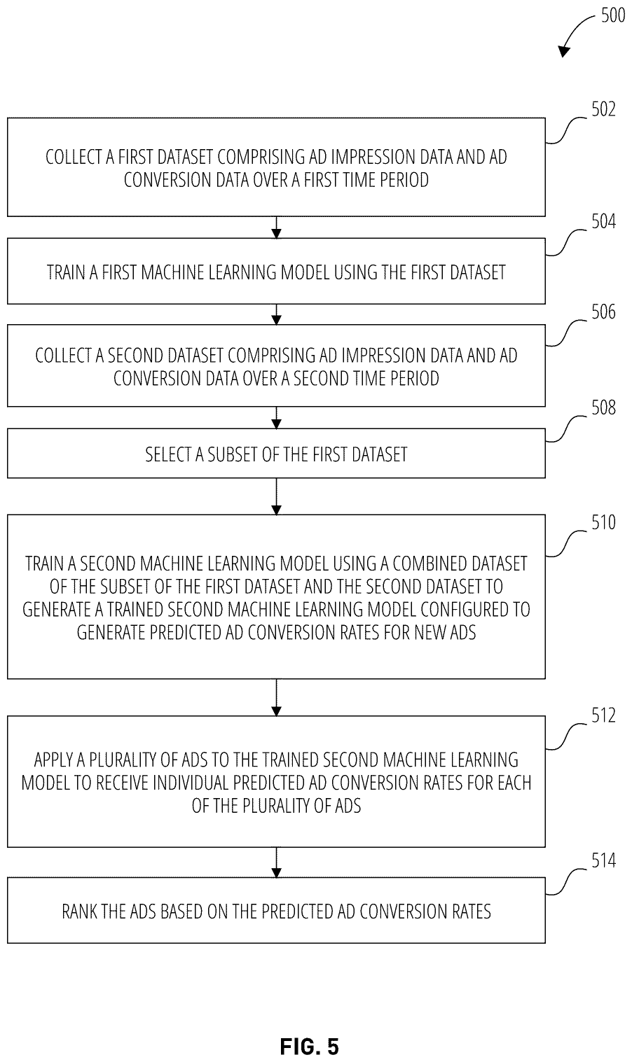

FIG. 5 illustrates an example method 500 for training a predictive ad conversion machine learning model using historical data retention, according to some examples. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

FIG. 4 is described as being performed by certain systems or applying certain processes, such as a particular predictive ad conversion machine learning model, but the processes described herein can be performed by one or more other machine learning models, or a combination thereof.

At block 502, the interaction system collects a first dataset comprising ad impression data and ad conversion data over a first time period. The interaction system begins its process by collecting a first dataset. This dataset includes ad impression data and ad conversion data, capturing the interactions and outcomes associated with advertisements over a specific time period, designated as the first time period.

Ad impressions of the dataset records each time an ad is displayed to a user. Ad impressions are critical metrics, as they reflect the reach of the ads and serve as a foundational data point for analyzing user engagement.

Conversions capture the instances where the impressions lead to conversions. Conversions can vary depending on the campaign's objectives and can include actions such as clicks, purchases, sign-ups, or any other targeted user activities that the ad aims to generate.

Collecting both impression and conversion data provides a comprehensive view of the ads'performance. This dual data approach allows the system to understand not only how frequently the ads are viewed but also how effectively they drive user actions.

The data collected during this first time period establishes a baseline for the model's understanding of ad effectiveness. By analyzing this data, the model can identify patterns and factors that influence user responses to different types of ads.

The interaction system may apply web tracking tools, cookies, server logs, and direct feedback mechanisms from digital ad platforms to gather this data. In other cases, the interaction system may gain access to data that is available by third parties.

The interaction system is designed with strict adherence to user privacy and data protection standards, ensuring that the collection and utilization of ad impression data and ad conversion data are conducted only with the explicit consent of the users. This means that the features involving the use of user data, as described in the data collection process, are activated only if the user opts into data sharing. This opt-in requirement is in compliance with privacy regulations such as GDPR and CCPA, which emphasize user consent as a cornerstone of data privacy. By implementing such measures, the system not only protects user privacy but also builds trust by transparently managing data according to user preferences and legal standards.

In some cases, the interaction system applies a sliding window such that there is overlapping data between the first and second datasets. For example, if the first dataset comprises ad impression and conversion data collected over a 30-day period from June 1 to July 1, the system then collects the second dataset for the next period, which starts just one day later July 2.

In some cases, the time periods and data used for training models do not overlap. This approach can include collecting discrete datasets for successive time periods without any shared days or data points between them. For example, a model trained on data from the first quarter of the year (January to March) might be followed by training on data from the second quarter (April to June) with no overlap.

In some cases, the overlap between consecutive datasets can be strategically defined either as a percentage of the dataset or as a specific number of days. This flexibility allows model developers to tailor the data overlap to the specific needs of the analysis or the dynamics of the target environment. For instance, setting the overlap to 20% would mean that the last 20% of the data from the first dataset also appears in the beginning of the subsequent dataset, ensuring continuity in the data stream. Alternatively, specifying a fixed number of days, such as 10 days, as the overlap ensures that the most recent 10 days of data from the first period are used again at the start of the next period.

The first time period can be predefined (e.g., a month, a quarter) and is selected based on the business cycle, campaign duration, or historical data availability. The specific choice of time period plays a critical role in capturing relevant market dynamics and consumer behavior trends. In other cases, the interaction system dynamically determines time periods (as further described herein).

At block 504, the interaction system trains a first machine learning model using the first dataset. The interaction system uses the first dataset which includes ad impression and ad conversion data collected over a first time period.

Successfully training the first machine learning model provides a baseline capability for predicting ad conversions with limited data, such as a first set of data collected.

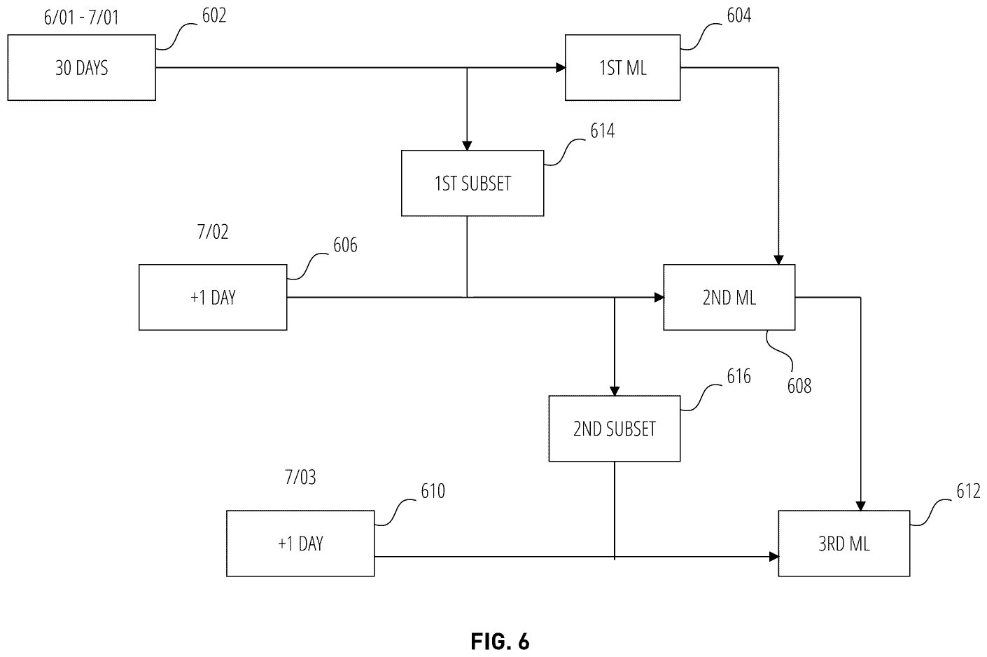

FIG. 6 illustrates an architectural diagram of historical data retention for ad performance prediction machine learning models, according to some examples. The interaction system gathers ad conversion and impression data for a first 30 day time window 602, such as between 6/01 to 7/01. This data is used to train the 1st machine learning model 604.

At block 506, the interaction system collects a second dataset comprising ad impression data and ad conversion data over a second time period. The interaction system gathers a second dataset that includes ad impression data and ad conversion data spanning a distinct second time period by capturing new and ongoing interactions with advertisements that have occurred subsequent to the period covered by the first dataset.

By collecting this fresh dataset, the system incorporates the most recent advertising activities and user responses enabling adapting and improving of the machine learning model's accuracy and relevance.

Collecting continuous and/or sequential datasets helps in identifying trends, such as shifts in user preferences or the effectiveness of different ad campaigns, ensuring that the machine learning model remains robust and responsive to the dynamic nature of user interactions and market conditions.

For example, the interaction system of FIG. 6 collects a new second dataset 606 at a second time period 7/02. The second time period is offset from the first time period by 1 day. The second dataset includes data from 7/02.

At block 508, the interaction system selects a subset of the first dataset. In conjunction with FIG. 6, the interaction system identifies a first subset of data 614. The first subset of data can include a subset of the first dataset.

The subset can be selected randomly, such as a certain number of data points or a certain percentage of the first dataset. In some cases, the selection of a subset can be dynamic based on significant trends, anomalies, and/or outliers that could provide deeper insights into user behavior and ad effectiveness.

In some cases, the subset may be chosen to maintain a balance of data points to avoid overfitting to overly frequent or rare occurrences in the first dataset. Different subsets of the 30-day period can be made based on various criteria, including high engagement days using user engagement metrics, such as click-through rates or time spent on ads, were notably higher than average, high conversion days with days that recorded above-average conversion rates, indicating successful ad performances, event-driven data with data from days when specific marketing campaigns or major events occurred, offering unique insights into user responses to different marketing strategies, anomaly days with days that deviate from typical patterns, which could highlight emerging trends or shifts in user behavior, or representative sampling using a statistically chosen sample that reflects the overall characteristics of the 30-day period, ensuring a comprehensive overview without biases toward any specific time segment.

In some cases, the time periods, overlaps, and/or identifying subsets of data can be adjusted, such as dynamically based on circumstances. For example, the interaction system can dynamically adjust time periods, overlaps, and/or subsets of data based on seasonal trends. In industries where consumer behavior is heavily influenced by seasonal trends, such as retail or travel, the interaction system can dynamically adjust the time periods, overlaps, or subsets of data to focus on relevant seasonal data can improve the accuracy of predictions related to peak or low seasons.

In some cases, the interaction system can dynamically adjust time periods, overlaps, and/or subsets of data based on market changes indicative of rapid changes in the market, such as those caused by economic shifts, new regulations, or technological innovations, may necessitate adjustments in the training time periods to ensure the model remains up-to-date with the latest trends and data.

In some cases, the interaction system can dynamically adjust time periods, overlaps, and/or subsets of data based on product launches around the launch of new products or services, where the models are trained on shorter, more recent time periods to quickly learn from the initial reactions and performance of the new offerings.

In some cases, the interaction system can dynamically adjust time periods, overlaps, and/or subsets of data based on data availability. For example, when there is a sudden increase in data availability—perhaps due to a marketing campaign or a new data collection strategy—the interaction system shortens the training period to help models quickly integrate this new information and adjust their predictions accordingly.

In some cases, the interaction system can dynamically adjust time periods, overlaps, and/or subsets of data based on anomaly detection. If anomalies or outliers are detected (e.g., a spike in ad clicks due to a viral campaign), the system may dynamically adjust the training window to either focus on or exclude this period, depending on the desired learning outcome.

In some cases, the interaction system can dynamically adjust time periods, overlaps, and/or subsets of data based on performance degradation. If model performance metrics indicate a decline, the interaction system can alter the time period considered for training to exclude outdated or less relevant data and include more current data that might be more predictive.

In some cases, the interaction system can dynamically adjust time periods, overlaps, and/or subsets of data based on resource constraints. In situations where computational or storage resources are limited, adjusting the training intervals can help manage the load, focusing on the most impactful data while discarding older or less relevant data.

In some cases, the interaction system can dynamically adjust time periods, overlaps, and/or subsets of data based on new market entrants or shifts. When new competitors enter the market or there are significant shifts in market dynamics, updating the training periods can help models adapt to the altered competitive landscape.

In some cases, the interaction system can dynamically adjust time periods, overlaps, and/or subsets of data based on customer behavior changes. If significant changes in customer behavior are observed, such as during economic downturns or after major social events, adjusting the time periods for training can help the model better understand and predict new purchasing patterns.

At block 510, the interaction system trains a second machine learning model using a combined dataset of the subset of the first dataset and the second dataset to generate a trained second machine learning model configured to generate predicted ad conversion rates for new ads. This combination provides a more nuanced training input that incorporates elements of historical data along with the most recent information available. The subset from the first dataset brings in vital historical patterns that are crucial for maintaining an understanding of longer-term trends, while the second dataset introduces fresh data reflecting the latest user interactions and market conditions.

During this training phase, various machine learning techniques are applied to assimilate and learn from this diverse data pool. The interaction system can adjust model parameters to minimize prediction error, employ regularization techniques to avoid overfitting, and/or use ensemble methods or advanced algorithms to enhance prediction accuracy. The model's architecture, whether it be a deep learning network, a decision tree ensemble, or another algorithmic approach, is calibrated to handle the complexity introduced by the merged datasets, ensuring the model can effectively use both historical and recent data to forecast future ad conversions.

When training the second machine learning model for the current time period (e.g., the second time period), the system can use the previously trained model (ML1) as a starting point. This approach leverages the knowledge and parameters learned in the last time period, allowing the new model to build upon existing insights while integrating the latest data. By doing so, the system benefits from a continuity in learning, where the new model is fine-tuned based on the most recent changes in data while retaining the valuable patterns recognized by the older model.

In some cases, the system may opt to train the new model entirely from scratch, without using the previous model as a baseline. This dynamic or continuous feature can be beneficial when the underlying data has changed significantly, or when there's a need to eliminate any potential biases or errors inherited from the previous model. Training a new model from the ground up ensures that it is fully responsive to the current dataset, free from the influence of past models.

In some cases, the interaction system uses a model from an earlier time period, rather than the most recent one, as the baseline for the new model. For example, the new model (e.g., ML50) might be based on a model from 10 periods ago (e.g., ML40), rather than the immediately prior model (e.g., ML49). This approach can be useful in cases where the older model captures long-term trends or patterns that are more relevant to the current data, especially when the data used for training overlaps only partially or not at all with the intervening periods. This method allows the system to revisit and re-integrate previous learnings that might have been overshadowed by more recent, but less relevant, data.

As shown in FIG. 6, the 2nd ML 608 is trained using the 1st subset 614 and newly collected data from the second time period 606, which includes data from 7/02. As shown, the 2nd ML's starting point is the 1st ML.

At block 512, the interaction system applies a plurality of ads to the trained machine learning model to receive individual predicted ad conversion rates for each of the plurality of ads. The interaction system inputs characteristics of each ad, such as its content, target audience, timing, and previous performance metrics, into the model. The model then uses the patterns and relationships it has learned during training to estimate the likelihood that each ad will achieve its conversion goals, such as prompting a purchase or a sign-up.

By generating individual predicted conversion rates, the model provides actionable insights that can guide decision-making around which ads to prioritize, modify, or discard based on their projected performance. The output of this process allows for more strategic allocation of resources, ensuring that the most effective ads are given prominence in the advertising strategy.

At block 514, the interaction system ranks the ads based on the predicted ad conversion rates. The interaction system can apply the ranking to perform actions, such as determining the order in which the ads will be presented or prioritized in a campaign. The system takes the predicted conversion rates for each ad—indicating the likelihood of achieving the desired user actions—and arranges the ads from highest to lowest based on these rates. Ads with higher predicted conversion rates are ranked higher, signaling that they are more likely to perform well for conversions and should be prioritized in the ad placement strategy.

The interaction system can use the rankings generated based on predicted ad conversion rates for automated ad selection and display. The interaction system can automatically select and display the highest-ranked ad in a specific ad space, ensuring the most effective ad is shown to the user. In some cases, the interaction system can rotate ads based on ranking scores, where higher-ranked ads are shown more frequently and/or in the beginning than lower-ranked ones. The interaction system can prioritize the display of ads during peak engagement times to maximize conversion opportunities.

The interaction system can perform ad bidding optimization based on the rankings. The interaction system can filter out lower-ranked ads before entering them into bidding campaigns, ensuring only the most promising ads compete for placement. The interaction system can adjust bid amounts dynamically based on ranking, allocating higher bids to ads with better predicted conversion rates to secure premium placements. The interaction system can segment ads into different bidding strategies, such as aggressive bidding for top-ranked ads and conservative bidding for lower-ranked ones.

The interaction system can enable budget allocation based on the rankings. The interaction system can allocate advertising budget proportionally based on ranking, with more budget assigned to higher-ranked ads. The interaction system can implement a budget cap for lower-ranked ads to prevent overspending on less effective campaigns. The interaction system can adjust daily or weekly budget distribution dynamically based on ongoing ranking assessments.

The interaction system can make campaign strategy adjustments based on the rankings. The interaction system can redirect resources from underperforming ads to those with higher rankings to improve overall campaign efficiency. The interaction system can use ranking data to inform decisions on pausing, modifying, or discontinuing ads that consistently rank low. The interaction system can tailor ad creatives or messaging based on ranking insights to improve performance in future iterations.

The interaction system can refine audience targeting based on the rankings. The interaction system can adjust audience targeting parameters based on the performance of ads within different audience segments, as reflected in the rankings. The interaction system can create lookalike audiences from users who interacted with higher-ranked ads to expand reach effectively. The interaction system can personalize ad experiences by showing specific ranked ads to audience segments most likely to convert.

The interaction system can enable A/B testing and experimentation using the rankings. The interaction system can run A/B tests with different ad versions, using ranking to determine which versions to continue scaling. The interaction system can experiment with different ad placements or formats, using ranking feedback to optimize choices. The interaction system can test new ad concepts by initially ranking them against existing ads to assess potential performance before full deployment.

The interaction system can generate real-time reports that track how rankings evolve over time, providing insights into campaign performance. The interaction system can monitor ad performance based on ranking to identify trends, such as seasonal shifts in ad effectiveness. The interaction system can use historical ranking data to forecast future ad performance and guide long-term strategy.

In FIG. 6, the process continues with the training of the third machine learning model (3rd ML 612). The 3rd model is initialized using the final state of the 2nd model as its starting point by carrying over the learned parameters, weights, and biases from the 2nd model into the 3rd model. By doing so, the system ensures continuity in learning, allowing the 3rd model to build upon the insights and patterns identified by the 2nd model, while also adapting to new data. This approach leverages the cumulative knowledge gained from the previous training stages, which can enhance the model's ability to generalize and predict accurately.

The input to the 3rd model includes the second subset of data 616 and data from the third time period 610. The 2nd subset is selected from the data used to train the 2nd model. By combining these two data sources, the 3rd model is trained on a dataset that is both rich in historical context and current in relevance.

Systems and methods described herein include training a machine learning network, such as training to identify conversion statistics or rankings using historical data retention. The machine learning network can be trained to determine conversion statistics of new ads, such as for a target audience or a targeted ad space. The machine learning algorithm can be trained using historical information that include historical impression data, and resulting conversion data.

Training of models, such as artificial intelligence models, is necessarily rooted in computer technology, and improves modeling technology by using training data to train such models and thereafter applying the models to new inputs to make inferences on the new inputs. Here, the new inputs can be a group of impressions for an ad bidding campaign or budget allocations for a plurality of ads. The trained machine learning model can determine rankings for such ads and make dynamic adjustments accordingly.

Such training involves complex processing that typically requires a lot of processor computing and extended periods of time with large training data sets, which are typically performed by massive server systems. Training of models can require logistic regression and/or forward/backward propagating of training data that can include input data and expected output values that are used to adjust parameters of the models. Such training is the framework of machine learning algorithms that enable the models to be applied to new and unseen data (such as new impression data) and make predictions that the model was trained for based on the weights or scores that were adjusted during training. Such training of the machine learning models described herein reduces false positives and increases the performance.

### Alternative Embodiments to Historical Data Retention Machine Learning Model Training

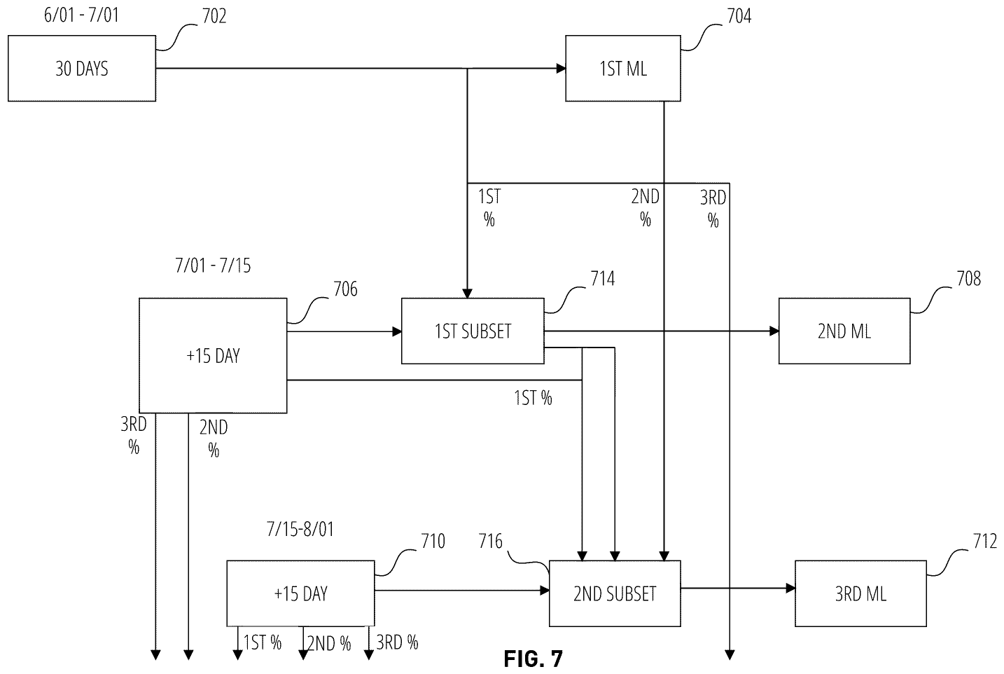

FIG. 7 illustrates an example of alternative periodic continuous retraining of the model, according to some examples. Similar to FIG. 6, data from the first time period 702 is used to train a first machine learning model (1st ML 704).

For the second time period, the interaction system sets the time period to be a 15-day window. For example, the first time period could be from June 1 to July 1, the second time period from July 1 to July 15, and the third time period from July 15 to August 1.

This overlap ensures that critical data around the transition between time periods is included in multiple training datasets, reducing the risk of the model missing out on important trends or events that occur around the boundaries of these periods. The overlap can help the model maintain a more continuous understanding of trends, particularly those that may span the boundary of two time periods.

The dataset from the first time period is used when determining subsets of data at subsequent times. For example, the dataset from the first time period is used when determining multiple subsets of data at a later time, such as the 1st subset of data 714 and the 2nd subset of data 716.

For example, the new ML model (e.g., the 2nd ML 708) is trained using a combination of a subset from the previous dataset (e.g., data from the first subset 702) and the full current dataset (e.g., data from the second time period 706). This approach allows the model to retain important historical data while focusing on the most recent data.

Moreover, the second subset includes data from the first time period and data from the second time period. In some cases, weightings are applied to the prior datasets. The second subset can include a percentage of the first subset along with the complete second dataset. For example, the interaction system can apply 50% of the first subset of data with the full dataset from the second time period to generate the first subset.

The second subset can be composed of a percentage of the first dataset, the second dataset, the first subset, and/or a combination thereof. This approach creates a more balanced blend of old and new data, ensuring that neither dataset dominates the learning process.

In some cases, a smaller percentage of the first subset is combined with a larger percentage of the second dataset to generate the second subset. This prioritizes the latest data while still incorporating some historical information. For example, the 1st % can be 50%, the 2nd % can be 30%, and the 3rd % can be 10%. As such, the first subset includes 50% of the data from the first time period and all of the data from the second time period. The second subset can include 30% of the data from the first time period, 50% of the data from the second time period, and all of the data from the third time period 710, to generate the 3rd ML 712.

Data from the first, second, and third time periods can be used to generate the fourth subset at reduced percentages, and so forth.

The interaction system continuously increases the amount of training data by incorporating an increasing percentage of historical data. As the model evolves, the interaction system continues to include more and more historical data, potentially extending far back into past datasets.

In some cases, the model takes a smaller percentage of historical data but goes back further in time to include data from earlier periods. This method maintains the training data at a manageable size while ensuring that the model considers a broader historical context. This is particularly useful in situations where older data may still have relevance, but the volume of historical data needs to be controlled to prevent the model from becoming too large and unwieldy.

In some cases, the model introduces a forgetting factor, which assigns more weight to data from the beginning of the first subset, gradually reducing the influence of older data. The forgetting factor allows the model to give greater importance to recent data, acknowledging that it is likely more indicative of current trends and behaviors. By adjusting these weights dynamically, the model can be tuned to either retain more historical data or focus more heavily on recent inputs. This technique helps balance the need for historical continuity with the requirement to stay current with new trends.

As shown in FIG. 7, each machine learning (ML) model is trained from scratch, meaning that the training process does not use any parameters, weights, or learned knowledge from previously trained models. Instead, every new model begins with an initialization phase where all the parameters are set to their initial values, typically random or based on some standard starting condition.

This method ensures that each model is independent and not influenced by any biases or errors that may have been present in previous models. Training fresh can be particularly useful when there is a significant change in the underlying data patterns, or when a completely new analysis is required.

### Dual Model Training Architecture

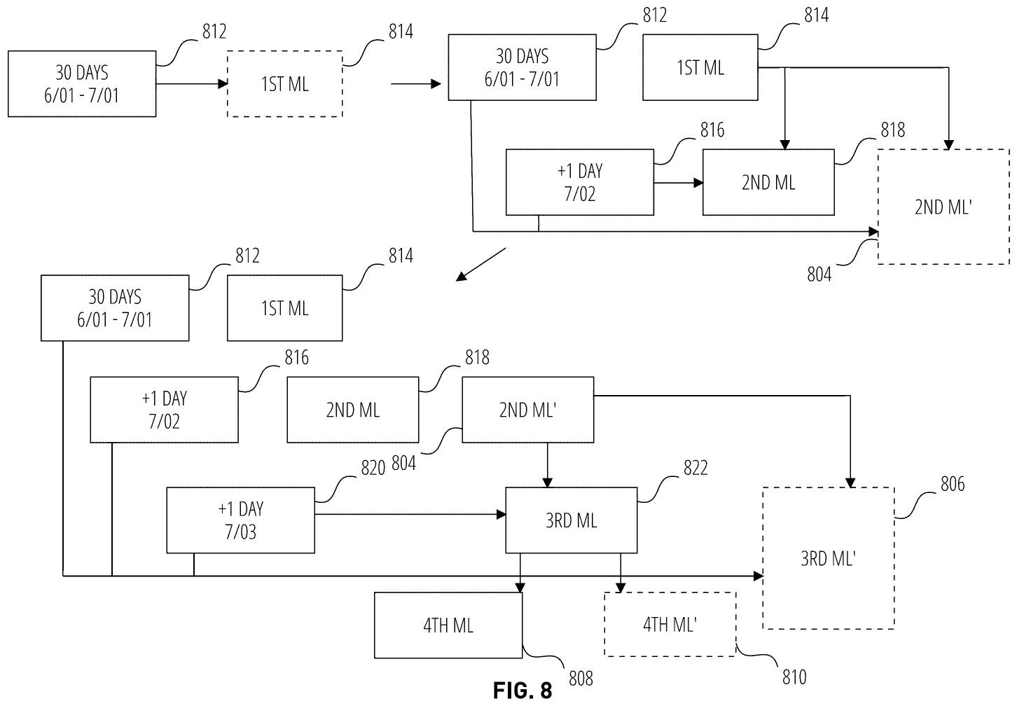

FIG. 8 illustrates dual model training architecture, according to some examples. At the first step of this new process, the interaction system begins by training the first machine learning model 814 using the first dataset 812, which includes ad impression data and ad conversion data collected over a 30-day period from June 1 to July 1. The first dataset is the only data available at this stage, so the model is trained to learn patterns, trends, and relationships within this specific time frame.

The model captures the nuances and behaviors specific to this 30-day window, establishing an initial understanding of how ad impressions correlate with conversions. This trained model is then launched into the product for customer use, and serves as the starting point or “parent”for the next model in the series (ML2).

In the next stage of this process, the interaction system takes the first trained machine learning model and makes two copies to proceed with the training for the subsequent time period. These two copies are designated as the second machine learning model (e.g., 2nd ML 818) and the second machine learning model prime (2nd ML′ 804). Each model is trained differently to serve distinct purposes in the overall system.

The 2nd ML is trained exclusively on the new dataset, such as the dataset collected from the time period of July 2. This dataset reflects the most recent ad impression and conversion data, capturing the latest trends and behaviors relevant to the ad campaigns.

The primary goal of ML2 is to adapt quickly to the new data, learning the latest patterns without being influenced by historical data at this stage. This model is essential for maintaining responsiveness to the most current user interactions and market dynamics. Once trained, ML2 is saved, but not deployed to the product suite (e.g., being available for use by customers). Instead, the model serves as the “parent” or baseline model for the next training cycle, where it will contribute to the creation of ML3.

The second copy, 2nd ML′, undergoes a more comprehensive training process by being trained on both the new dataset July 2 and at least a portion of the historical dataset from the previous time period, June 1 to July 1. This combined dataset allows the 2nd ML′ to retain valuable insights from past data while also incorporating the most recent information.

The 2nd ML′ leverages both historical knowledge and current data, enhancing its ability to generalize and predict future ad conversions more accurately. This model is intended to be more robust, as it balances the need to stay current with the benefit of long-term learning. Unlike ML2, ML2′ can be the model that is launched into the product, where it will be used to make real-time predictions and drive ad performance.

In the subsequent stage of the process, the system advances to train the third set of machine learning models using the knowledge accumulated from the previous models.

Similar to the previous stage, the interaction system creates two models—3rd ML 822 and 3rd ML′ 806—each with a distinct training approach to optimize performance and generalization.

The system begins by copying the second machine learning model (ML2) as the parent model for the next iteration. A copy of ML2 is made, and this copy becomes the starting point for both the 3rd ML and the 3rd ML′.

The 3rd ML is then trained exclusively on the newest dataset 820, which covers the period from July 3. This dataset includes the most recent ad impression and conversion data, reflecting the latest user behaviors and market trends. In parallel, the system creates another copy of ML2, which is designated as the 3rd ML′. This model is trained on a combined dataset that includes data from all three time periods: June 1 to July 1, July 2, and July 3.

The process is then repeated for the fourth model iteration, such as for the 4th ML 808 and the 4th ML′ 810. This dual-model training approach continues with each new time period, ensuring that one model (ML4) remains highly responsive to the latest data, while the other model (ML4′) benefits from the cumulative knowledge of all historical datasets. ML4′ is then deployed live, providing a robust and generalizable model for real-time predictions.

In other cases, the next time period (such as the next day) includes more or less than one unit of data (such as more than one day, e.g., 6/2-7/2). In some cases, the next set of data overlaps with the previous set of data (e.g., 6/1-7/1 and 6/15-7/15). In other cases, the next set of data does not overlap with the previous set of data (e.g., 6/1-6/30 and 7/1-7/31).

### Data Communications Architecture

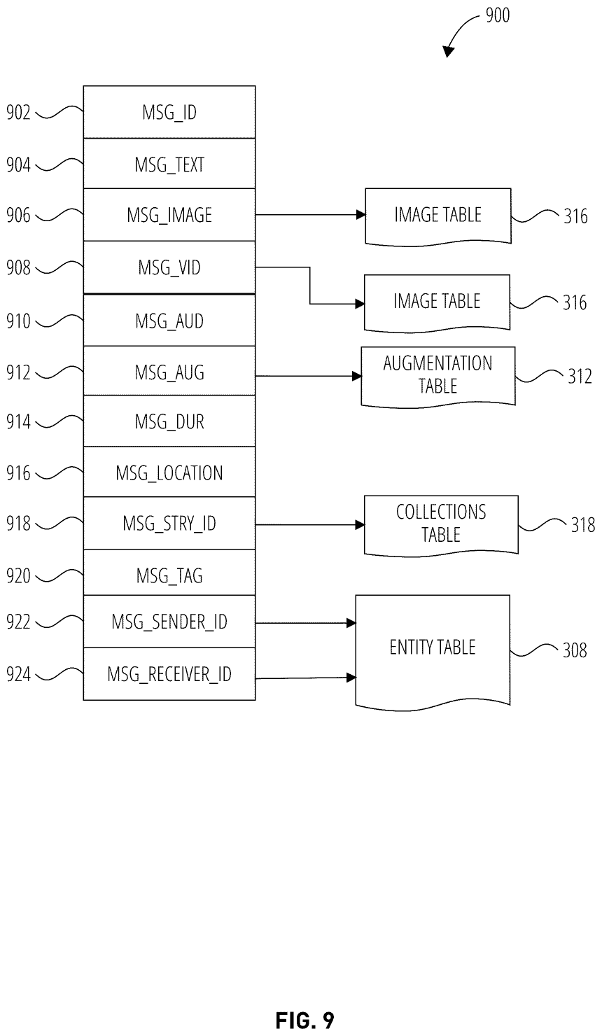

FIG. 9 is a schematic diagram illustrating a structure of a message 900, according to some examples, generated by an interaction client 104 for communication to a further interaction client 104 via the interaction servers 124. The content of a particular message 900 is used to populate the message table 306 stored within the database 304, accessible by the interaction servers 124. Similarly, the content of a message 900 is stored in memory as “in-transit” or “in-flight” data of the user system 102 or the interaction servers 124. A message 900 is shown to include the following example components:
Message identifier 902: a unique identifier that identifies the message 900.
Message text payload 904: text, to be generated by a user via a user interface of the user system 102, and that is included in the message 900.
Message image payload 906: image data, captured by a camera component of a user system 102 or retrieved from a memory component of a user system 102, and that is included in the message 900. Image data for a sent or received message 900 may be stored in the image table 316.
Message video payload 908: video data, captured by a camera component or retrieved from a memory component of the user system 102, and that is included in the message 900. Video data for a sent or received message 900 may be stored in the image table 316.
Message audio payload 910: audio data, captured by a microphone or retrieved from a memory component of the user system 102, and that is included in the message 900.
Message augmentation data 912: augmentation data (e.g., filters, stickers, or other annotations or enhancements) that represents augmentations to be applied to message image payload 906, message video payload 908, or message audio payload 910 of the message 900. Augmentation data for a sent or received message 900 may be stored in the augmentation table 312.
Message duration parameter 914: parameter value indicating, in seconds, the amount of time for which content of the message (e.g., the message image payload 906, message video payload 908, message audio payload 910) is to be presented or made accessible to a user via the interaction client 104.
Message geolocation parameter 916: geolocation data (e.g., latitudinal and longitudinal coordinates) associated with the content payload of the message. Multiple message geolocation parameter 916 values may be included in the payload, each of these parameter values being associated with respect to content items included in the content (e.g., a specific image within the message image payload 906, or a specific video in the message video payload 908).
Message story identifier 918: identifier values identifying one or more content collections (e.g., “stories” identified in the collections table 318) with which a particular content item in the message image payload 906 of the message 900 is associated. For example, multiple images within the message image payload 906 may each be associated with multiple content collections using identifier values.
Message tag 920: each message 900 may be tagged with multiple tags, each of which is indicative of the subject matter of content included in the message payload. For example, where a particular image included in the message image payload 906 depicts an animal (e.g., a lion), a tag value may be included within the message tag 920 that is indicative of the relevant animal. Tag values may be generated manually, based on user input, or may be automatically generated using, for example, image recognition.
Message sender identifier 922: an identifier (e.g., a messaging system identifier, email address, or device identifier) indicative of a user of the user system 102 on which the message 900 was generated and from which the message 900 was sent.
Message receiver identifier 924: an identifier (e.g., a messaging system identifier, email address, or device identifier) indicative of a user of the user system 102 to which the message 900 is addressed.

The contents (e.g., values) of the various components of message 900 may be pointers to locations in tables within which content data values are stored. For example, an image value in the message image payload 906 may be a pointer to (or address of) a location within an image table 316. Similarly, values within the message video payload 908 may point to data stored within an image or video table 316, values stored within the message augmentation data 912 may point to data stored in an augmentation table 312, values stored within the message story identifier 918 may point to data stored in a collections table 318, and values stored within the message sender identifier 922 and the message receiver identifier 924 may point to user records stored within an entity table 308.

### System with Head-Wearable Apparatus

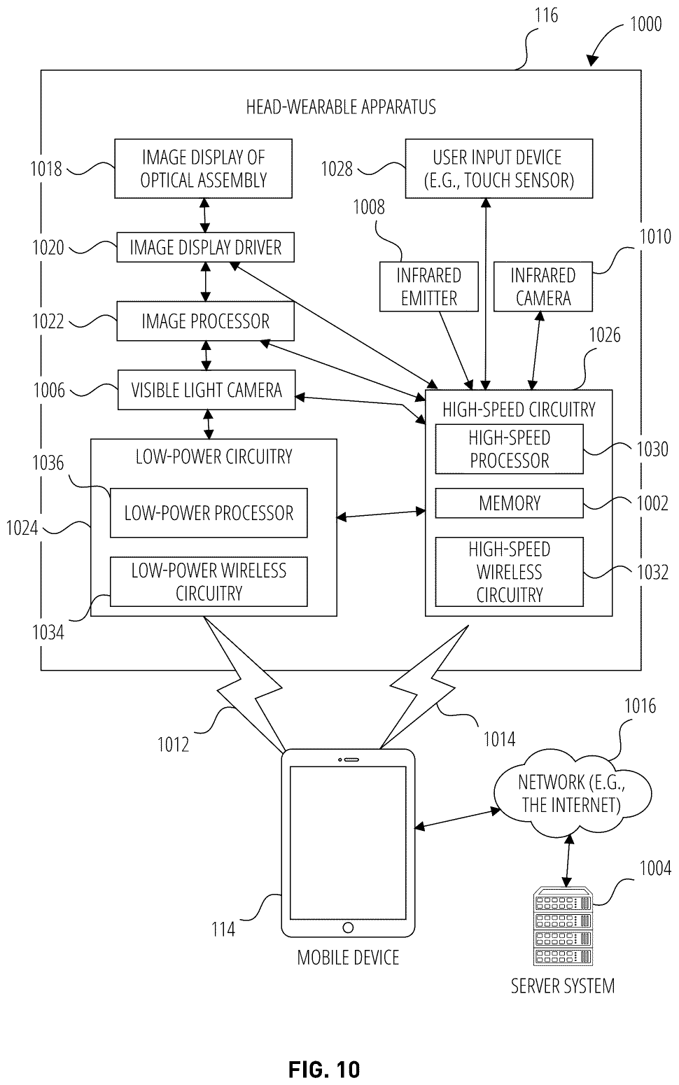

FIG. 10 illustrates a system 1000 including a head-wearable apparatus 116 with a selector input device, according to some examples. FIG. 10 is a high-level functional block diagram of an example head-wearable apparatus 116 communicatively coupled to a mobile device 114 and various server systems 1004 (e.g., the interaction server system 110) via various networks 108. The networks 108 may include any combination of wired and wireless connections.

The head-wearable apparatus 116 includes one or more cameras, each of which may be, for example, a visible light camera 1006, an infrared emitter 1008, and an infrared camera 1010.

An interaction client, such as a mobile device 114 connects with head-wearable apparatus 116 using both a low-power wireless connection 1012 and a high-speed wireless connection 1014. The mobile device 114 is also connected to the server system 1004 and the network 1016.

The head-wearable apparatus 116 further includes two image displays of the image display of optical assembly 1018. The two image displays of optical assembly 1018 include one associated with the left lateral side and one associated with the right lateral side of the head-wearable apparatus 116. The head-wearable apparatus 116 also includes an image display driver 1020, an image processor 1022, low-power circuitry 1024, and high-speed circuitry 1026. The image display of optical assembly 1018 is for presenting images and videos, including an image that can include a graphical user interface to a user of the head-wearable apparatus 116.

The image display driver 1020 commands and controls the image display of optical assembly 1018. The image display driver 1020 may deliver image data directly to the image display of optical assembly 1018 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 1028 (e.g., touch sensor or push button), including an input surface on the head-wearable apparatus 116. The user input device 1028 (e.g., touch sensor or push button) is to receive from the user an input selection to manipulate the graphical user interface of the presented image.

The components shown in FIG. 10 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 1006 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 1002, which stores instructions to perform a subset or all of the functions described herein. The memory 1002 can also include storage device.

As shown in FIG. 10, the high-speed circuitry 1026 includes a high-speed processor 1030, a memory 1002, and high-speed wireless circuitry 1032. In some examples, the image display driver 1020 is coupled to the high-speed circuitry 1026 and operated by the high-speed processor 1030 in order to drive the left and right image displays of the image display of optical assembly 1018. The high-speed processor 1030 may be any processor capable of managing high-speed communications and operation of any general computing system needed for the head-wearable apparatus 116. The high-speed processor 1030 includes processing resources needed for managing high-speed data transfers on a high-speed wireless connection 1014 to a wireless local area network (WLAN) using the high-speed wireless circuitry 1032. In certain examples, the high-speed processor 1030 executes an operating system such as a LINUX operating system or other such operating system of the head-wearable apparatus 116, and the operating system is stored in the memory 1002 for execution. In addition to any other responsibilities, the high-speed processor 1030 executing a software architecture for the head-wearable apparatus 116 is used to manage data transfers with high-speed wireless circuitry 1032. In certain examples, the high-speed wireless circuitry 1032 is configured to implement Institute of Electrical and Electronic Engineers (IEEE) 802.11 communication standards, also referred to herein as WI-FI®. In some examples, other high-speed communications standards may be implemented by the high-speed wireless circuitry 1032.

The low-power wireless circuitry 1034 and the high-speed wireless circuitry 1032 of the head-wearable apparatus 116 can include short-range transceivers (Bluetooth™) and wireless wide, local, or wide area network transceivers (e.g., cellular or WI-FI®). Mobile device 114, including the transceivers communicating via the low-power wireless connection 1012 and the high-speed wireless connection 1014, may be implemented using details of the architecture of the head-wearable apparatus 116, as can other elements of the network 1016.

The memory 1002 includes any storage device capable of storing various data and applications, including, among other things, camera data generated by the left and right visible light cameras 1006, the infrared camera 1010, and the image processor 1022, as well as images generated for display by the image display driver 1020 on the image displays of the image display of optical assembly 1018. While the memory 1002 is shown as integrated with high-speed circuitry 1026, in some examples, the memory 1002 may be an independent standalone element of the head-wearable apparatus 116. In certain such examples, electrical routing lines may provide a connection through a chip that includes the high-speed processor 1030 from the image processor 1022 or the low-power processor 1036 to the memory 1002. In some examples, the high-speed processor 1030 may manage addressing of the memory 1002 such that the low-power processor 1036 will boot the high-speed processor 1030 any time that a read or write operation involving memory 1002 is needed.

As shown in FIG. 10, the low-power processor 1036 or high-speed processor 1030 of the head-wearable apparatus 116 can be coupled to the camera (visible light camera 1006, infrared emitter 1008, or infrared camera 1010), the image display driver 1020, the user input device 1028 (e.g., touch sensor or push button), and the memory 1002.

The head-wearable apparatus 116 is connected to a host computer. For example, the head-wearable apparatus 116 is paired with the mobile device 114 via the high-speed wireless connection 1014 or connected to the server system 1004 via the network 1016. The server system 1004 may be one or more computing devices as part of a service or network computing system, for example, that includes a processor, a memory, and network communication interface to communicate over the network 1016 with the mobile device 114 and the head-wearable apparatus 116.

The mobile device 114 includes a processor and a network communication interface coupled to the processor. The network communication interface allows for communication over the network 1016, low-power wireless connection 1012, or high-speed wireless connection 1014. Mobile device 114 can further store at least portions of the instructions in the mobile device 114's memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 1020. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 1004, such as the user input device 1028, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include biometric sensors, additional sensors, or display elements integrated with the head-wearable apparatus 116. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1012 and high-speed wireless connection 1014 from the mobile device 114 via the low-power wireless circuitry 1034 or high-speed wireless circuitry 1032.

### Machine Architecture

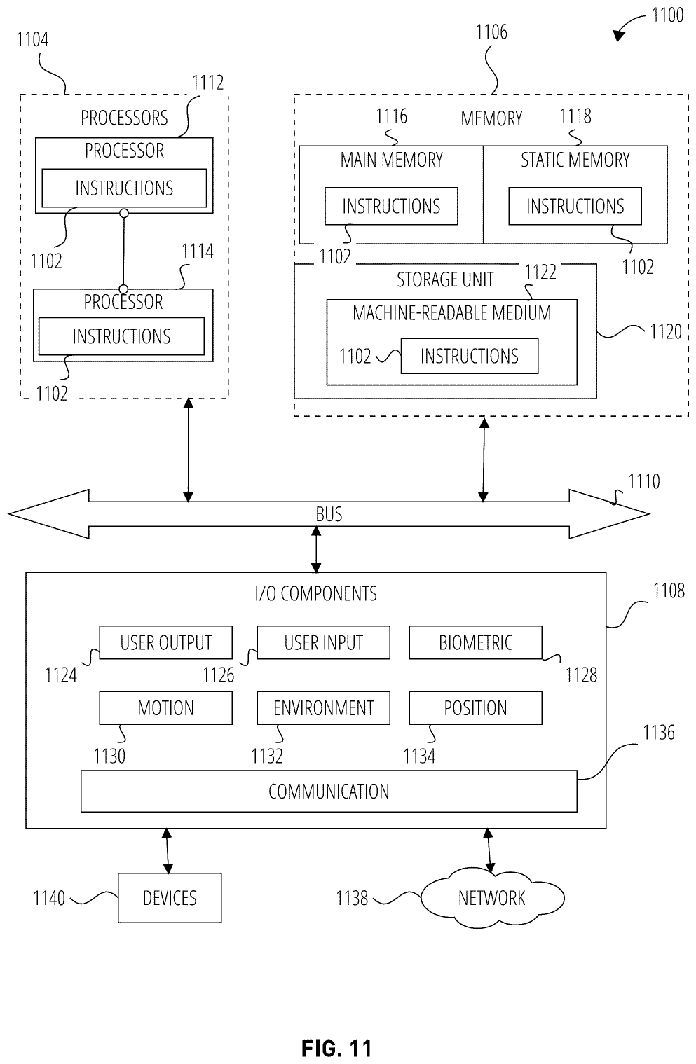

FIG. 11 is a diagrammatic representation of the machine 1100 within which instructions 1102 (e.g., software, a program, an application, an applet, an app, or other executable code) for causing the machine 1100 to perform any one or more of the methodologies discussed herein may be executed. For example, the instructions 1102 may cause the machine 1100 to execute any one or more of the methods described herein. The instructions 1102 transform the general, non-programmed machine 1100 into a particular machine 1100 programmed to carry out the described and illustrated functions in the manner described. The machine 1100 may operate as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1102, sequentially or otherwise, that specify actions to be taken by the machine 1100. Further, while a single machine 1100 is illustrated, the term “machine” shall also be taken to include a collection of machines that individually or jointly execute the instructions 1102 to perform any one or more of the methodologies discussed herein. The machine 1100, for example, may comprise the user system 102 or any one of multiple server devices forming part of the interaction server system 110. In some examples, the machine 1100 may also comprise both client and server systems, with certain operations of a particular method or algorithm being performed on the server-side and with certain operations of the particular method or algorithm being performed on the client-side.

The machine 1100 may include processors 1104, memory 1106, and input/output I/O components 1108, which may be configured to communicate with each other via a bus 1110. In an example, the processors 1104 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1112 and a processor 1114 that execute the instructions 1102. The term “processor” is intended to include multi-core processors that may comprise two or more independent processors (sometimes referred to as “cores”) that may execute instructions contemporaneously. Although FIG. 11 shows multiple processors 1104, the machine 1100 may include a single processor with a single-core, a single processor with multiple cores (e.g., a multi-core processor), multiple processors with a single core, multiple processors with multiples cores, or any combination thereof.

The memory 1106 includes a main memory 1116, a static memory 1118, and a storage unit 1120, both accessible to the processors 1104 via the bus 1110. The main memory 1106, the static memory 1118, and storage unit 1120 store the instructions 1102 embodying any one or more of the methodologies or functions described herein. The instructions 1102 may also reside, completely or partially, within the main memory 1116, within the static memory 1118, within machine-readable medium 1122 within the storage unit 1120, within at least one of the processors 1104 (e.g., within the processor's cache memory), or any suitable combination thereof, during execution thereof by the machine 1100.

The I/O components 1108 may include a wide variety of components to receive input, provide output, produce output, transmit information, exchange information, capture measurements, and so on. The specific I/O components 1108 that are included in a particular machine will depend on the type of machine. For example, portable machines such as mobile phones may include a touch input device or other such input mechanisms, while a headless server machine will likely not include such a touch input device. It will be appreciated that the I/O components 1108 may include many other components that are not shown in FIG. 11. In various examples, the I/O components 1108 may include user output components 1124 and user input components 1126. The user output components 1124 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1126 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1108 may include biometric components 1128, motion components 1130, environmental components 1132, or position components 1134, among a wide array of other components. For example, the biometric components 1128 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like.

The motion components 1130 include acceleration sensor components (e.g., accelerometer), gravitation sensor components, rotation sensor components (e.g., gyroscope).

The environmental components 1132 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 1134 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1108 further include communication components 1136 operable to couple the machine 1100 to a network 1138 or devices 1140 via respective coupling or connections. For example, the communication components 1136 may include a network interface component or another suitable device to interface with the network 1138. In further examples, the communication components 1136 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1140 may be another machine or any of a wide variety of peripheral devices (e.g., a peripheral device coupled via a USB).

Moreover, the communication components 1136 may detect identifiers or include components operable to detect identifiers. For example, the communication components 1136 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, DataglyphTM, MaxiCode, PDF417, Ultra Code, UCC RSS-2D bar code, and other optical codes), or acoustic detection components (e.g., microphones to identify tagged audio signals). In addition, a variety of information may be derived via the communication components 1136, such as location via Internet Protocol (IP) geolocation, location via Wi-Fi® signal triangulation, location via detecting an NFC beacon signal that may indicate a particular location, and so forth.

The various memories (e.g., main memory 1116, static memory 1118, and memory of the processors 1104) and storage unit 1120 may store one or more sets of instructions and data structures (e.g., software) embodying or used by any one or more of the methodologies or functions described herein. These instructions (e.g., the instructions 1102), when executed by processors 1104, cause various operations to implement the disclosed examples.

The instructions 1102 may be transmitted or received over the network 1138, using a transmission medium, via a network interface device (e.g., a network interface component included in the communication components 1136) and using any one of several well-known transfer protocols (e.g., hypertext transfer protocol (HTTP)). Similarly, the instructions 1102 may be transmitted or received using a transmission medium via a coupling (e.g., a peer-to-peer coupling) to the devices 1140.

### Software Architecture

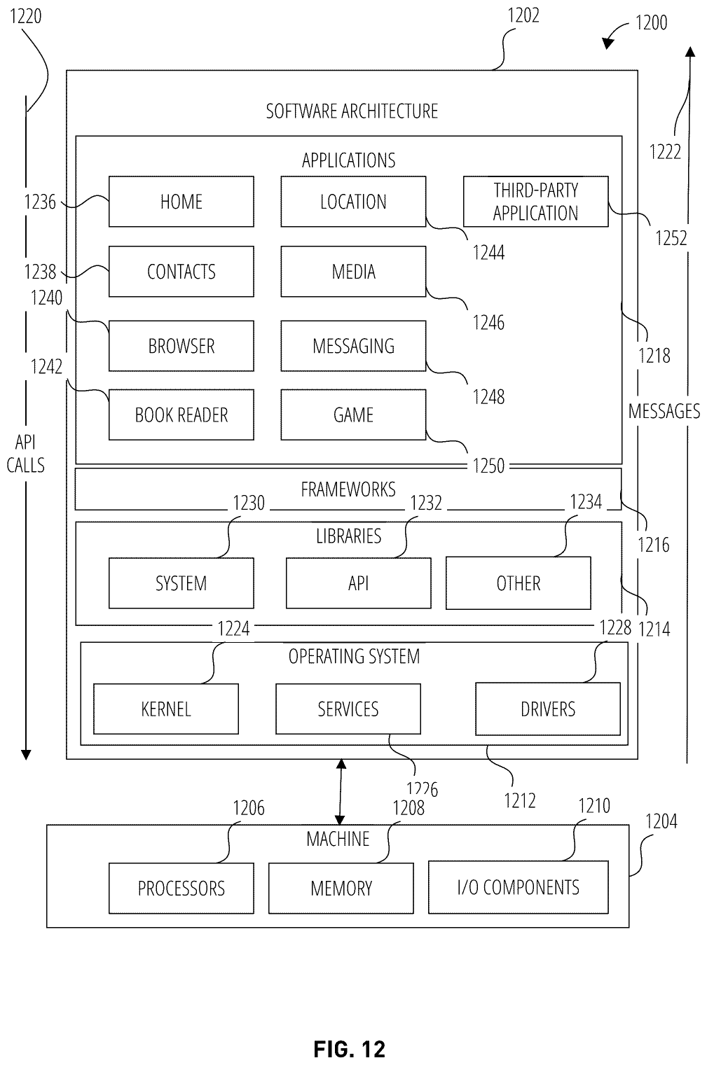

FIG. 12 is a block diagram 1200 illustrating a software architecture 1202, which can be installed on any one or more of the devices described herein. The software architecture 1202 is supported by hardware such as a machine 1204 that includes processors 1206, memory 1208, and I/O components 1210. In this example, the software architecture 1202 can be conceptualized as a stack of layers, where each layer provides a particular functionality. The software architecture 1202 includes layers such as an operating system 1212, libraries 1214, frameworks 1216, and applications 1218. Operationally, the applications 1218 invoke API calls 1220 through the software stack and receive messages 1222 in response to the API calls 1220.

The operating system 1212 manages hardware resources and provides common services. The operating system 1212 includes, for example, a kernel 1224, services 1226, and drivers 1228. The kernel 1224 acts as an abstraction layer between the hardware and the other software layers. For example, the kernel 1224 provides memory management, processor management (e.g., scheduling), component management, networking, and security settings, among other functionalities. The services 1226 can provide other common services for the other software layers. The drivers 1228 are responsible for controlling or interfacing with the underlying hardware. For instance, the drivers 1228 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1214 provide a common low-level infrastructure used by the applications 1218. The libraries 1214 can include system libraries 1230 (e.g., C standard library) that provide functions such as memory allocation functions, string manipulation functions, mathematic functions, and the like. In addition, the libraries 1214 can include API libraries 1232 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1214 can also include a wide variety of other libraries 1234 to provide many other APIs to the applications 1218.

The frameworks 1216 provide a common high-level infrastructure that is used by the applications 1218. For example, the frameworks 1216 provide various graphical user interface (GUI) functions, high-level resource management, and high-level location services. The frameworks 1216 can provide a broad spectrum of other APIs that can be used by the applications 1218, some of which may be specific to a particular operating system or platform.

In an example, the applications 1218 may include a home application 1236, a contacts application 1238, a browser application 1240, a book reader application 1242, a location application 1244, a media application 1246, a messaging application 1248, a game application 1250, and a broad assortment of other applications such as a third-party application 1252. The applications 1218 are programs that execute functions defined in the programs. Various programming languages can be employed to create one or more of the applications 1218, structured in a variety of manners, such as object-oriented programming languages (e.g., Objective-C, Java, or C++) or procedural programming languages (e.g., C or assembly language). In a specific example, the third-party application 1252 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1252 can invoke the API calls 1220 provided by the operating system 1212 to facilitate functionalities described herein.

### Machine-Learning Pipeline

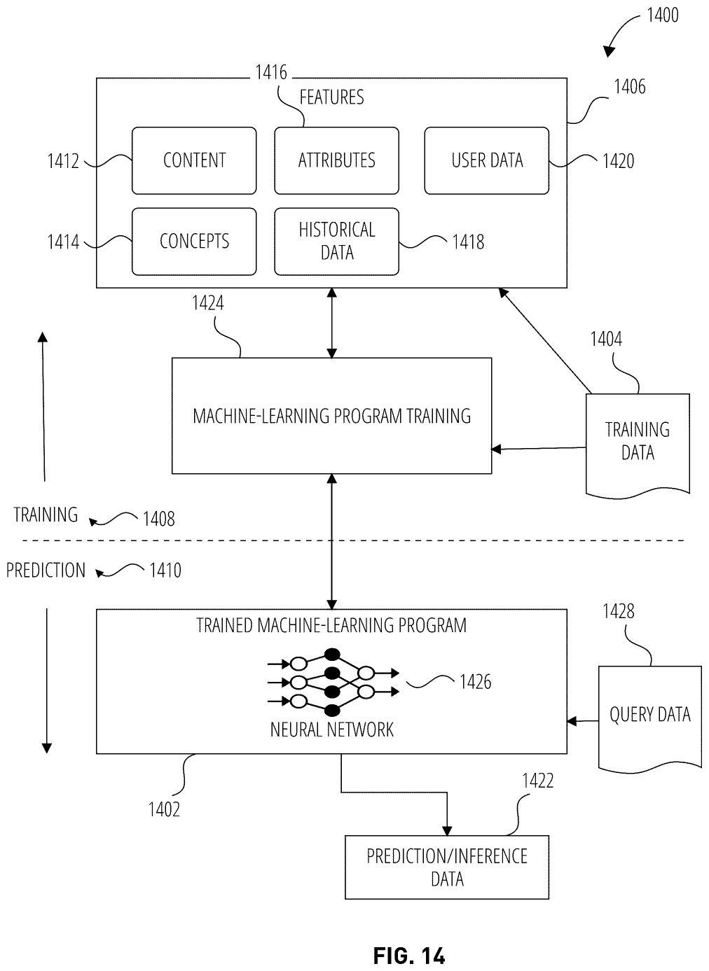

FIG. 14 is a flowchart depicting a machine-learning pipeline 1400, according to some examples. The machine-learning pipelines 1400 may be used to generate a trained model, for example the trained machine-learning program 1402 of FIG. 14, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naüve Bayes, which is another supervised learning algorithm used for classification tasks. Naüve Bayes is based on Bayes'theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

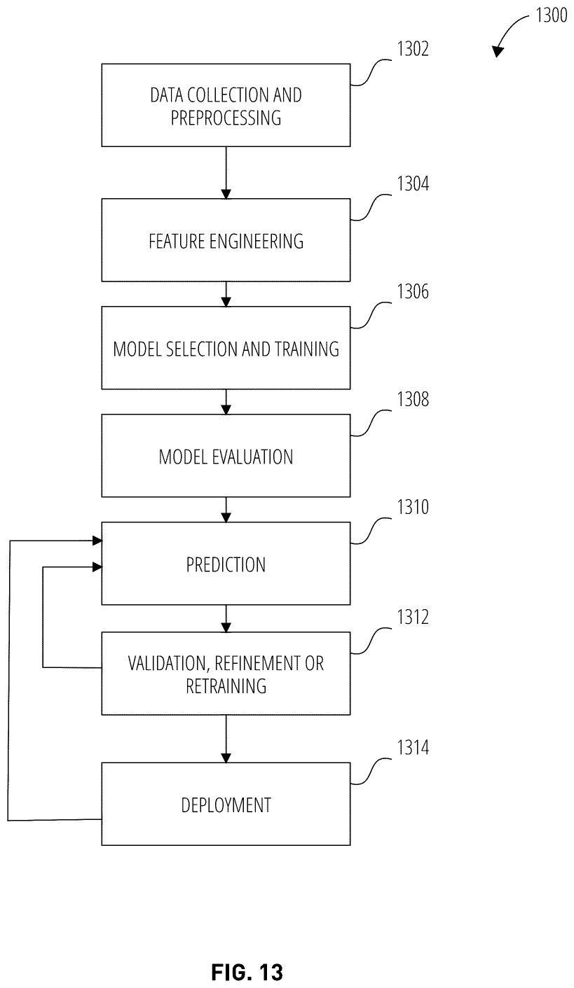

Generating a trained machine-learning program 1402 may include multiple types of phases that form part of the machine-learning pipeline 1400, including for example the following phases 1300 illustrated in FIG. 13:
Data collection and preprocessing 1302: This may include acquiring and cleaning data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
Feature engineering 1304: This may include selecting and transforming the training data 1404 to create features that are useful for predicting the target variable. Feature engineering may include (1) receiving features 1406 (e.g., as structured or labeled data in supervised learning) and/or (2) identifying features 1406 (e.g., unstructured or unlabeled data for unsupervised learning) in training data 1404.
Model selection and training 1306: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
Model evaluation 1308: This may include evaluating the performance of a trained model (e.g., the trained machine-learning program 1402) on a separate testing dataset. This can help determine if the model is overfitting or underfitting and if it is suitable for deployment.
Prediction 1310: This involves using a trained model (e.g., trained machine-learning program 1402) to generate predictions on new, unseen data.
Validation, refinement or retraining 1312: This may include updating a model based on feedback generated from the prediction phase, such as new data or user feedback.
Deployment 1314: This may include integrating the trained model (e.g., the trained machine-learning program 1402) into a larger system or application, such as a web service, mobile app, or IoT device. This can involve setting up APIs, building a user interface, and ensuring that the model is scalable and can handle large volumes of data.

FIG. 14 illustrates two example phases, namely a training phase 1408 (part of the model selection and trainings 1306) and a prediction phase 1410 (part of prediction 1310). Prior to the training phase 1408, feature engineering 1304 is used to identify features 1406. This may include identifying informative, discriminating, and independent features for the effective operation of the trained machine-learning program 1402 in pattern recognition, classification, and regression. In some examples, the training data 1404 includes labeled data, which is known data for pre-identified features 1406 and one or more outcomes.

Each of the features 1406 may be a variable or attribute, such as individual measurable property of a process, article, system, or phenomenon represented by a data set (e.g., the training data 1404). Features 1406 may also be of different types, such as numeric features, strings, vectors, matrices, encodings, and graphs, and may include one or more of content 1412, concepts 1414, attributes 1416, historical data 1418 and/or user data 1420, merely for example. Concept features can include abstract relationships or patterns in data, such as determining a topic of a document or discussion in a chat window between users. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like. Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click-through rates, or engagement metrics), or user preferences (such as preferences to certain video, text, or digital content items). Historical data includes past events or trends that can help identify patterns or relationships over time.

In training phases 1408, the machine-learning pipeline 1400 uses the training data 1404 to find correlations among the features 1406 that affect a predicted outcome or prediction/inference data 1422.

With the training data 1404 and the identified features 1406, the trained machine-learning program 1402 is trained during the training phase 1408 during machine-learning program training 1424. The machine-learning program training 1424 appraises values of the features 1406 as they correlate to the training data 1404. The result of the training is the trained machine-learning program 1402 (e.g., a trained or learned model).

Further, the training phase 1408 may involve machine learning, in which the training data 1404 is structured (e.g., labeled during preprocessing operations), and the trained machine-learning program 1402 implements a relatively simple neural network 1426 capable of performing, for example, classification and clustering operations. In other examples, the training phase 1408 may involve deep learning, in which the training data 1404 is unstructured, and the trained machine-learning program 1402 implements a deep neural network 1426 that is able to perform both feature extraction and classification/clustering operations.

A neural network 1426 may, in some examples, be generated during the training phase 1408, and implemented within the trained machine-learning program 1402. The neural network 1426 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 1426 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 1426 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1408, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 1426 is iteratively trained by adjusting model parameters to minimize a specific loss function or maximize a certain objective. The system can continue to train the neural network 1426 by adjusting parameters based on the output of the validation, refinement, or retraining block 1312, and rerun the prediction 1310 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 1426 even after deployment 1314 of the neural network 1426. The neural network 1426 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 1410, the trained machine-learning program 1402 uses the features 1406 for analyzing query data 1428 to generate inferences, outcomes, or predictions, as examples of a prediction/inference data 1422. For example, during prediction phase 1410, the trained machine-learning program 1402 is used to generate an output. Query data 1428 is provided as an input to the trained machine-learning program 1402, and the trained machine-learning program 1402 generates the prediction/inference data 1422 as output, responsive to receipt of the query data 1428. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 1402 may be a generative AI model. Generative AI is a term that may refer to any type of artificial intelligence that can create new content from training data 1404. For example, generative AI can produce text, images, video, audio, code or synthetic data that are similar to the original data but not identical.

Some of the techniques that may be used in generative AI are:
Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 1422 that is output include trend assessment and predictions, translations, summaries, image or video recognition and categorization, natural language processing, face recognition, user sentiment assessments, advertisement targeting and optimization, voice recognition, or media content generation, recommendation, and personalization.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.
Example 1 is a system comprising: at least one processor; and at least one memory component storing instructions that, when executed by the at least one processor, cause the at least one processor to perform operations comprising: collecting a first dataset comprising ad impression data and ad conversion data over a first time period; training a first machine learning model using the first dataset; collecting a second dataset comprising ad impression data and ad conversion data over a second time period; selecting a subset of the first dataset; training a second machine learning model using a combined dataset of the subset of the first dataset and the second dataset to generate a trained second machine learning model configured to generate predicted ad conversion rates for new ads; applying a plurality of ads to the trained second machine learning model to receive individual predicted ad conversion rates for each of the plurality of ads; and ranking the plurality of ads based on the predicted ad conversion rates.
In Example 2, the subject matter of Example 1 includes, wherein the second time period is subsequent to the first time period.
In Example 3, the subject matter of Examples 1-2 includes, wherein the first time period includes overlapping consecutive days with the second time period, wherein the subset of the first dataset includes at least one overlapping day with the second dataset.
In Example 4, the subject matter of Examples 1-3 includes, wherein the first time period does not include overlapping days with the second time period, wherein the first dataset does not include overlapping data with the second dataset.
In Example 5, the subject matter of Examples 1-4 includes, the operations further comprising: periodically retraining the second machine learning model based on a new dataset of ad impression data and ad conversion data at a new time period and a subset of data from a dataset prior to the new time period.
In Example 6, the subject matter of Examples 1-5 includes, wherein selecting the subset includes randomly selecting a predetermined amount or percentage of the first dataset.
In Example 7, the subject matter of Examples 1-6 includes, wherein selecting the subset includes dynamically selecting an amount or percentage of the first dataset based on the amount of data availability in the first dataset.
In Example 8, the subject matter of Examples 1-7 includes, wherein selecting the subset includes dynamically selecting an amount or percentage of the first dataset based on anomaly detection of outlier data in the first dataset.
In Example 9, the subject matter of Examples 1-8 includes, wherein selecting the subset includes dynamically selecting an amount or percentage of the first dataset based on a performance degradation metric of the first machine learning model.
In Example 10, the subject matter of Examples 1-9 includes, wherein selecting the subset includes dynamically selecting an amount or percentage of the first dataset based on a resource constraint of a user consumer device, the training of the second machine learning model being performed on the user consumer device.
In Example 11, the subject matter of Examples 1-10 includes, wherein the second machine learning model is a new model that is not derived from the first machine learning model.
In Example 12, the subject matter of Examples 1-11 includes, wherein the second machine learning model is the first machine learning model, wherein training the second machine learning model includes retraining the first machine learning model to generate the trained second machine learning model.
In Example 13, the subject matter of Examples 1-12 includes, wherein the second machine learning model is a third machine learning model that was trained using ad impression data and ad conversion data over a third time period, wherein the first time period is subsequent to the second time period, wherein the second time period is subsequent to the third time period.
In Example 14, the subject matter of Examples 1-13 includes, wherein the operations further comprise automatically causing display of the highest-ranked ad of the plurality of ads in a particular ad space.
In Example 15, the subject matter of Examples 1-14 includes, wherein the operations further comprise automatically adjusting bid amounts of the plurality of the ads based on the ranking prior to execution of bid auctioning for the plurality of ads.
In Example 16, the subject matter of Examples 1-15 includes, wherein the operations further comprise automatically adjusting budget allocations for each of the ads based on the rankings.
In Example 17, the subject matter of Examples 1-16 includes, wherein the operations comprise applying a weighting to the subset of the first dataset, wherein training the second machine learning model is further based on the applied weighting to the subset of the first dataset.
Example 18 is a method comprising: collecting a first dataset comprising ad impression data and ad conversion data over a first time period; training a first machine learning model using the first dataset; collecting a second dataset comprising ad impression data and ad conversion data over a second time period; selecting a subset of the first dataset; training a second machine learning model using a combined dataset of the subset of the first dataset and the second dataset to generate a trained second machine learning model configured to generate predicted ad conversion rates for new ads; applying a plurality of ads to the trained second machine learning model to receive individual predicted ad conversion rates for each of the plurality of ads; and ranking the plurality of ads based on the predicted ad conversion rates.
Example 19 is a non-transitory computer-readable storage medium storing instructions that, when executed by at least one processor, cause the at least one processor to perform operations comprising: collecting a first dataset comprising ad impression data and ad conversion data over a first time period; training a first machine learning model using the first dataset; collecting a second dataset comprising ad impression data and ad conversion data over a second time period; selecting a subset of the first dataset; training a second machine learning model using a combined dataset of the subset of the first dataset and the second dataset to generate a trained second machine learning model configured to generate predicted ad conversion rates for new ads; applying a plurality of ads to the trained second machine learning model to receive individual predicted ad conversion rates for each of the plurality of ads; and ranking the plurality of ads based on the predicted ad conversion rates.
Example 20 is at least one machine-readable medium including instructions that, when executed by processing circuitry, cause the processing circuitry to perform operations to implement any of Examples 1-19.
Example 21 is an apparatus comprising means to implement any of Examples 1-19.
Example 22 is a system to implement any of Examples 1-19.
Example 23 is a method to implement any of Examples 1-19.

### GLOSSARY

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

### CONCLUSION

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one processor; and
at least one memory component storing instructions that, when executed by the at least one processor, cause the at least one processor to perform operations comprising:
collecting a first dataset comprising ad impression data and ad conversion data over a first time period;
training a first machine learning model using the first dataset;
collecting a second dataset comprising ad impression data and ad conversion data over a second time period;
selecting a subset of the first dataset;
training a second machine learning model using a combined dataset of the subset of the first dataset and the second dataset to generate a trained second machine learning model configured to generate predicted ad conversion rates for new ads;
applying a plurality of ads to the trained second machine learning model to receive individual predicted ad conversion rates for each of the plurality of ads; and
ranking the plurality of ads based on the predicted ad conversion rates.

2. The system of claim 1, wherein the second time period is subsequent to the first time period.

3. The system of claim 1, wherein the first time period includes overlapping consecutive days with the second time period, wherein the subset of the first dataset includes at least one overlapping day with the second dataset.

4. The system of claim 1, wherein the first time period does not include overlapping days with the second time period, wherein the first dataset does not include overlapping data with the second dataset.

5. The system of claim 1, the operations further comprising:
periodically retraining the second machine learning model based on a new dataset of ad impression data and ad conversion data at a new time period and a subset of data from a dataset prior to the new time period.

6. The system of claim 1, wherein selecting the subset includes randomly selecting a predetermined amount or percentage of the first dataset.

7. The system of claim 1, wherein selecting the subset includes dynamically selecting an amount or percentage of the first dataset based on the amount of data availability in the first dataset.

8. The system of claim 1, wherein selecting the subset includes dynamically selecting an amount or percentage of the first dataset based on anomaly detection of outlier data in the first dataset.

9. The system of claim 1, wherein selecting the subset includes dynamically selecting an amount or percentage of the first dataset based on a performance degradation metric of the first machine learning model.

10. The system of claim 1, wherein selecting the subset includes dynamically selecting an amount or percentage of the first dataset based on a resource constraint of a user consumer device, the training of the second machine learning model being performed on the user consumer device.

11. The system of claim 1, wherein the second machine learning model is a new model that is not derived from the first machine learning model.

12. The system of claim 1, wherein the second machine learning model is the first machine learning model, wherein training the second machine learning model includes retraining the first machine learning model to generate the trained second machine learning model.

13. The system of claim 1, wherein the second machine learning model is a third machine learning model that was trained using ad impression data and ad conversion data over a third time period, wherein the first time period is subsequent to the second time period, wherein the second time period is subsequent to the third time period.

14. The system of claim 1, wherein the operations further comprise automatically causing display of the highest-ranked ad of the plurality of ads in a particular ad space.

15. The system of claim 1, wherein the operations further comprise automatically adjusting bid amounts of the plurality of the ads based on the ranking prior to execution of bid auctioning for the plurality of ads.

16. The system of claim 1, wherein the operations further comprise automatically adjusting budget allocations for each of the ads based on the rankings.

17. The system of claim 1, wherein the operations comprise applying a weighting to the subset of the first dataset, wherein training the second machine learning model is further based on the applied weighting to the subset of the first dataset.

18. A method comprising:
collecting a first dataset comprising ad impression data and ad conversion data over a first time period;
training a first machine learning model using the first dataset;
collecting a second dataset comprising ad impression data and ad conversion data over a second time period;
selecting a subset of the first dataset;
training a second machine learning model using a combined dataset of the subset of the first dataset and the second dataset to generate a trained second machine learning model configured to generate predicted ad conversion rates for new ads;
applying a plurality of ads to the trained second machine learning model to receive individual predicted ad conversion rates for each of the plurality of ads; and
ranking the plurality of ads based on the predicted ad conversion rates.

19. A non-transitory computer-readable storage medium storing instructions that, when executed by at least one processor, cause the at least one processor to perform operations comprising:
collecting a first dataset comprising ad impression data and ad conversion data over a first time period;
training a first machine learning model using the first dataset;
collecting a second dataset comprising ad impression data and ad conversion data over a second time period;
selecting a subset of the first dataset;
training a second machine learning model using a combined dataset of the subset of the first dataset and the second dataset to generate a trained second machine learning model configured to generate predicted ad conversion rates for new ads;
applying a plurality of ads to the trained second machine learning model to receive individual predicted ad conversion rates for each of the plurality of ads; and
ranking the plurality of ads based on the predicted ad conversion rates.
